(19) United States
(12) Patent Application Publication
(10) Pub. No.: US 2004/0158867 A1
(43) Pub. Date: Aug. 12, 2004

(54) Methods, systems, and apparatus for determining transport stream channels for video-on-demand applications

(75) Inventors: Robert E. Mack, Collegeville, PA (US); Arthur P. Jost, Mt. Laurel, NJ (US); Larry Rabinowitz, Cherry Hill, NJ (US); David Brumbaugh, Norristown, PA (US); Mark Gregotski, North Grafton, MA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/361,960

(22) Filed: Feb. 10, 2003

(51) Int. Cl. H04N 7/173

(52) U.S. Cl. 725/95; 725/98; 725/131

(57) ABSTRACT

The present invention enables determination of transport stream channels for video-on-demand (VOD) applications. A television terminal is provided which includes a tuner for tuning to a home channel. An application program interface in the terminal retrieves a transport stream identifier of a transport stream carrying the home channel. The home channel transport stream identifier defines a plurality of transport stream identifiers of a corresponding plurality of transport streams visible to the terminal. A video service controller receives the home channel transport stream identifier from the application program interface. A VOD subsystem controller controls distribution of a requested VOD service in response to video service controller commands. A video pump provides the requested VOD service to a re-multiplexing QAM device for distribution on one of the transport streams visible to the terminal based on commands from the VOD subsystem controller.

### BACKGROUND OF THE INVENTION

The present invention relates generally to the distribution of video-on-demand services in a digital cable television system. More specifically, the present invention relates to methods, systems, and apparatus for determining available transport stream channels for video-on-demand (VOD) applications.

Currently, various VOD vendors use different proprietary methods to identify which VOD server's transport stream channels (e.g., quadrature amplitude modulation (QAM) channels) are visible to particular television terminals. In some cases, the proprietary scheme used by a VOD vendor constrains each return path demodulator (RPD) to a limited number of television terminals. In these instances, substantially more RPDs must be deployed than would otherwise be required. The need to deploy such additional RPDs is a significant cost associated with implementing and operating a VOD system. Further, the additional RPDs and associated equipment require additional space requirements.

Some VOD vendors use proprietary schemes which do not require the deployment of additional equipment. However, these vendors may not be willing to share their technology and such schemes may not be practical for all VOD vendors.

It would be advantageous to provide a scheme for identifying transport stream channels which are visible to the television terminal which can be easily implemented by all VOD vendors. It would be further advantageous if such a scheme could be implemented using existing MPEG transport stream infrastructure and standard MPEG transport protocols.

The methods, systems, and apparatus of the present invention provide the foregoing and other advantages.

### SUMMARY OF THE INVENTION

The present invention provides methods, systems, and apparatus for determining transport stream channels for video-on-demand (VOD) applications. An example embodiment of a system in accordance with the invention includes a television terminal having a tuner for tuning to a home channel based on known identifiers. An application program interface residing in the television terminal is enabled to retrieve a transport stream identifier of a transport stream carrying the home channel. The transport stream identifier of the home channel defines a plurality of transport stream identifiers of a corresponding plurality of transport streams visible to the television terminal. A video service controller is enabled to receive the transport stream identifier of the home channel from the application program interface. A VOD subsystem controller controls distribution of a requested VOD service in response to commands received from the video service controller. A video pump is enabled to provide the requested VOD service to a re-multiplexing QAM device for distribution on one of the plurality of transport streams visible to the television terminal based on commands received from the VOD subsystem controller.

Inventive methods and apparatus corresponding to the system described above are also provided in accordance with the invention.

### BRIEF DESCRIPTION OF THE DRAWINGS

The present invention will hereinafter be described in conjunction with the appended drawing figures, wherein like numerals denote like elements, and:

FIG. 1 shows an example embodiment of a VOD delivery system in accordance with the invention;

FIG. 2 shows an example embodiment of a television terminal in accordance with the invention; and

FIG. 3 is a flowchart showing an example embodiment of the invention.

### DETAILED DESCRIPTION OF THE INVENTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

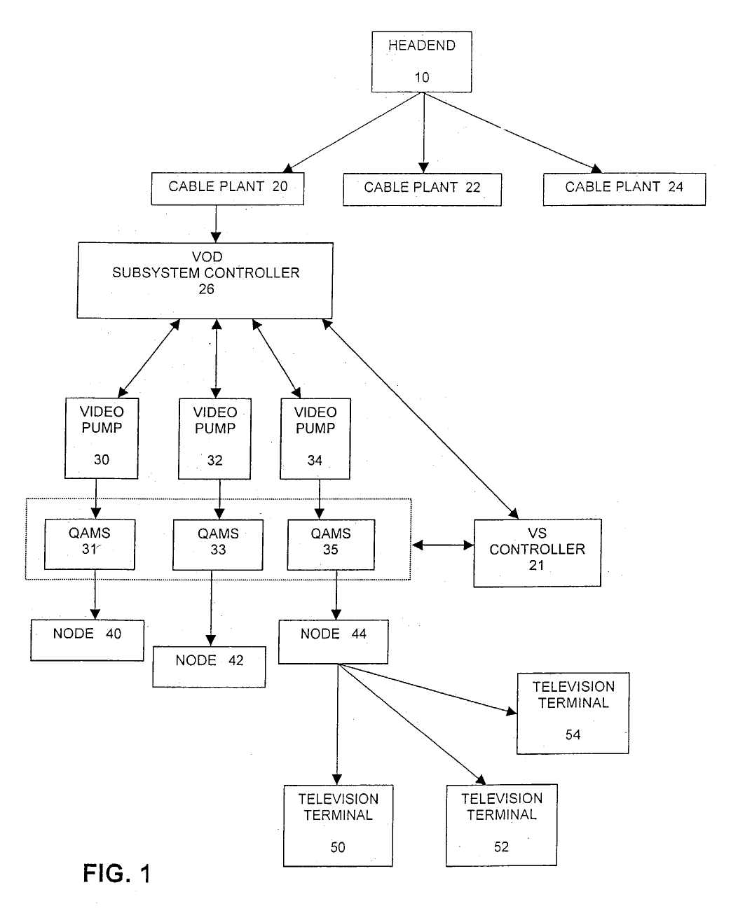

The present invention provides methods, systems, and apparatus for determining transport stream channels for video-on-demand (VOD) applications. A simplified example embodiment of a VOD delivery system in accordance with the invention is shown in FIG. 1. The system may include a cable headend 10 (which may be a local or regional headend). The headend 10 may control a plurality of cable plants 20, 22, and 24. Each cable plant may include at least one video service controller (VS controller) and one VOD subsystem controller, such as video service controller 21 and VOD subsystem controller 26 in cable plant 20. The video service controller 21 may provision pathways through the cable network to route the VOD service from video pumps 30, 32, and 0.34 to a selected QAM channel associated with the appropriate node. The VS controller 21 also communicates with the VOD subsystem controller 26 to complete the VOD session setup. The VOD subsystem controller 26 manages the video pumps 30, 32, and 34 and ultimately controls video service playout. In the system shown in FIG. 1, the VS controller 21 controls QAM devices 31, 33, and 35, and is responsible for routing the VOD service, provided by the video pumps 30, 32, and 34, to the selected QAM channel on the appropriate node 40, 42, and 44. It should be appreciated that in an alternate embodiment, the video pumps (also referred to in the art as video servers or VOD servers) may source the QAM outputs themselves. In these systems, the VOD subsystem controller may be responsible for selecting the appropriate QAM channel.

As shown in FIG. 1, VOD subsystem controller 26 at cable plant 20 controls video pumps 30, 32, and 34. Each video pump provides VOD services to at least one cable node. As shown in FIG. 1, video pumps 30, 32, and 34 provide VOD services to cable nodes 40, 42, and 44, respectively. Each cable node services a plurality of television terminals. Those skilled in the art will appreciate that although FIG. 1 shows only three television terminals 50, 52, and 54, a cable node may include a group of approximately 500 television terminals.

It should be appreciated that FIG. 1 is a simplified representation of a VOD distribution network, and that only those elements needed to understand the present invention are shown. Further, the present invention is equally applicable to satellite delivery systems and is not limited to the example cable embodiment shown in FIG. 1.

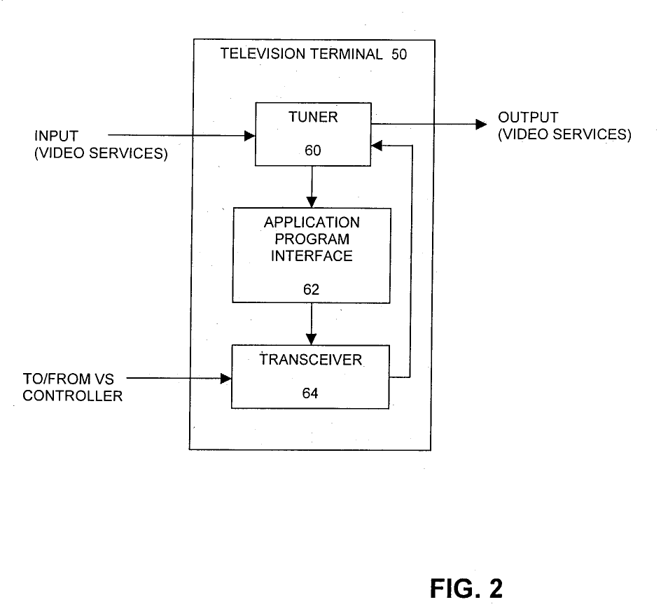

FIG. 2 shows an example embodiment of a television terminal 50 in accordance with the invention. A tuner 60 in the television terminal 50 is provided for tuning to a home channel based on known identifiers. An application program interface 62 residing in the television terminal 50 is enabled to retrieve a transport stream identifier of a transport stream carrying the home channel. The transport stream identifier of the home channel defines a plurality of transport stream identifiers of a corresponding plurality of transport streams visible to the television terminal 50. A video service controller 21 (shown in FIG. 1) is enabled to receive the transport stream identifier of the home channel from the application program interface 62 (e.g., communicated via transceiver 64 of the terminal 50). The VOD subsystem controller 26 controls the distribution of a requested VOD service based on commands from the video service controller 21. A video pump (e.g., video pump 34) transmits the requested VOD service to a re-multiplexing QAM device (e.g., QAM device 31, 33, or 35) that will place the requested VOD service on one of the plurality of transport streams visible to the television terminal 50 based on commands received from the VOD subsystem controller 26. The video service controller 21 may also signal the VOD subsystem controller 26 to inform a VOD client application executing within the terminal 50 (e.g., via transceiver 64) to tune to the appropriate channel for receipt of the requested VOD service from the video pump 34. The video service may then be output from the television terminal 50 to a display device (e.g., a television or the like) for display.

It should be appreciated that the television terminal 50 may be integrated into a television or other display device, or it may be a separate device as illustrated in FIG. 2.

It should also be appreciated that the VOD service may also be provided to the television terminal 50 via the home channel, which by definition comprises a transport stream visible to the television terminal 50.

Transport stream identifiers are typically located in Program Association Tables (PATs) carried in the transport streams. Each transport stream identifier may be related to a single QAM channel. Groups of transport stream identifiers may be related to a single cable system node (e.g., node 44), or perhaps groups of nodes. Each transport stream identifier may be unique across all VOD channels.

The known identifiers may comprise one of a source name or a home channel frequency, such as a known QAM frequency. For example, initially, the VOD client (i.e., the television terminal 50) will tune to its home channel by knowledge of a well-known source name (e.g., VendorName_Home) or perhaps a well-known QAM frequency (e.g. 653 MHz). Once tuned to the home channel, the application program interface 62 will extract the home channel transport stream identifier (TS_ID) and pass it upstream to the video service controller 21. The video service controller 21 then knows, based upon the returned TS_ID of the home channel, all other QAMs (and their corresponding TS_IDs) visible to that particular terminal 50.

The video service controller 21 may maintain a mapping of transport stream identifiers to corresponding transport streams, associated QAM channels, and destination nodes. This mapping may be in the form of a lookup table maintained at the video service controller 21. The transport streams are carried within QAM outputs and are associated with a particular node (i.e., a group of television terminals on a particular cable plant segment).

The VOD subsystem controller 26 and the video service controller 21 may service a plurality of nodes (e.g., nodes 40, 42, and 44). At least one of a common virtual channel table, a common source name table, or a common set of MPEG service numbers may be used across the plurality of nodes 40, 42, and 44.

Each transport stream identifier, which may be generated by the video service controller 21, is delivered to the appropriate QAM device. Each QAM device generates an outgoing PAT based on the services included in the outgoing transport stream. The PAT includes, among other information, the appropriate transport stream identifier for the transport stream. The PAT is then inserted into the transport stream by the QAM device. Those skilled in the art will appreciate that the QAM signals may be generated by the independent QAM modulators 31, 33, and 35 as shown in FIG. 1. Alternatively the QAM signals may be generated by the video pumps directly (e.g., video pumps 30, 32, and 34) so that no external QAM devices are required. In cases where the video pumps source the QAM signals directly, the VOD subsystem controller 26 may assign the appropriate outgoing transport stream identifiers, and shall maintain the mapping of transport stream identifiers to associated nodes or node groups.

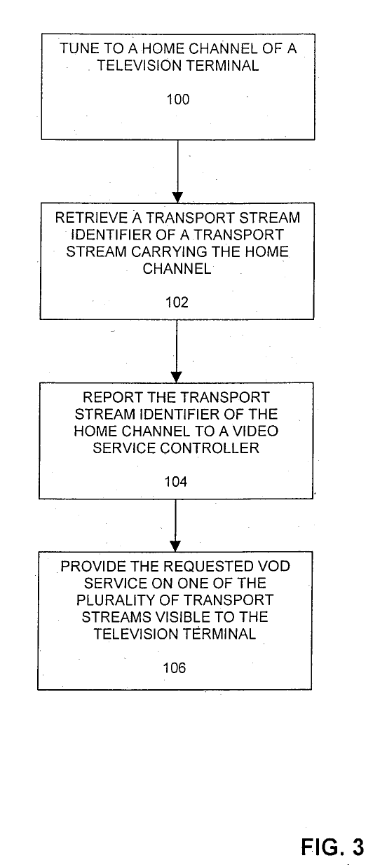

FIG. 3 is a flowchart illustrating an example embodiment of the invention. The television terminal initially tunes (Step 100) to a home channel of a television terminal based on known identifiers. Next, the television terminal (e.g., via an application program interface) retrieves a transport stream identifier of a transport stream carrying the home channel (Step 102). As discussed above, the transport stream identifier of the home channel defines a plurality of transport stream identifiers of a corresponding plurality of transport streams visible to the television terminal. The television terminal then reports the transport stream identifier of the home channel to a video service controller (Step 104). The video service controller then directs the VOD subsystem controller to provide the requested VOD service to one of the re-multiplexing QAM devices that provides one or more of the plurality of transport streams visible to the television terminal (Step 106). The video pumps send their content to the external QAM devices. The VS controller instructs the VOD subsystem controller where to send the VOD service. The VOD subsystem controller commands the appropriate video pump to transmit to the particular QAM device identified by the video service controller. The QAM device re-multiplexes a plurality of received VOD services/streams together (from one or more video pumps) and modulates and up-converts to RF for distribution to the cable plant nodes.

It should now be appreciated that the present invention provides advantageous methods, systems, and apparatus for determining the transport stream channels available for VOD applications.

Although the invention has been described in connection with various illustrated embodiments, numerous modifications and adaptations may be made thereto without departing from the spirit and scope of the invention as set forth in the claims.

What is claimed is:

1. A method for determining transport stream channels for video-on-demand (VOD) applications, comprising:
tuning to a home channel of a television terminal based on known identifiers;
retrieving a transport stream identifier of a transport stream carrying said home channel, said transport stream identifier of said home channel defining a plurality of transport stream identifiers of a corresponding plurality of transport streams visible to the television terminal;
reporting the transport stream identifier of said home channel to a video service controller; and
providing a requested VOD service on one of the plurality of transport streams visible to the television terminal.

2. A method in accordance with claim 1, wherein each transport stream identifier is related to a single QAM channel.

3. A method in accordance with claim 2, wherein groups of transport stream identifiers are related to a single cable system node.

4. A method in accordance with claim 1, wherein each transport stream identifier is unique across all VOD channels.

5. A method in accordance with claim 1, wherein said known identifiers comprise one of a source name or a home channel frequency.

6. A method in accordance with claim 1, wherein the video service controller maintains a mapping of transport stream identifiers to corresponding transport streams, associated QAM channels, and destination nodes.

7. A method in accordance with claim 1, wherein:
said video service controller services a plurality of nodes;
at least one of a common virtual channel table, a common source name table, or a common set of MPEG service numbers is used across said plurality of nodes; and
program association tables (PATs) carried in each transport stream contain unique transport stream identifiers.

8. A system for determining transport stream channels for video-on-demand (VOD) applications, comprising:
a tuner in a television terminal for tuning to a home channel based on known identifiers;
an application program interface residing in said television terminal and enabled to retrieve a transport stream identifier of a transport stream carrying said home channel, said transport stream identifier of said home channel defining a plurality of transport stream identifiers of a corresponding plurality of transport streams visible to the television terminal;
a video service controller enabled to receive the transport stream identifier of said home channel from the application program interface;
a VOD subsystem controller in communication with said video service controller for controlling distribution of a requested VOD service based on commands from said video service controller; and
a video pump enabled to provide the requested VOD service to a re-multiplexing QAM device for distribution on one of the plurality of transport streams visible to said television terminal based on commands received from said VOD subsystem controller.

9. A system in accordance with claim 8, wherein each transport stream identifier is related to a single QAM channel.

10. A system in accordance with claim 9, wherein groups of transport stream identifiers are related to a single-cable system node.

11. A system in accordance with claim 8, wherein each transport stream identifier is unique across all VOD channels.

12. A system in accordance with claim 8, wherein said known identifiers comprise one of a source name or a home channel frequency.

13. A system in accordance with claim 8, wherein the video service controller maintains a mapping of transport stream identifiers to corresponding transport streams, associated QAM channels, and destination nodes.

14. A system in accordance with claim 8, wherein:
said video service controller services a plurality of nodes;
at least one of a common virtual channel table, a common source name table, or a common set of MPEG service numbers is used across said plurality of nodes; and
program association tables (PATs) carried in each transport stream contain unique transport stream identifiers.

15. A television terminal enabled to determine transport stream channels for video-on-demand (VOD) applications, comprising:
a tuner for tuning to a home channel based on known identifiers; and
an application program interface enabled to retrieve a transport stream identifier of a transport stream carrying said home channel, said transport stream identifier of said home channel defining a plurality of transport stream identifiers of a corresponding plurality of transport streams visible to the television terminal;
wherein:
the television terminal is enabled to communicate the transport stream identifier of said home channel; and
the television terminal is enabled to receive a requested VOD service on one of the plurality of transport streams visible to said television terminal in response to the communication of the transport stream identifier of the home channel.

16. A television terminal in accordance with claim 15, wherein each transport stream identifier is related to a single QAM channel.

17. A television terminal in accordance with claim 16, wherein groups of transport stream identifiers are related to a single cable system node.

18. A television terminal in accordance with claim 15, wherein each transport stream identifier is unique across all VOD channels.

19. A television terminal in accordance with claim 15, wherein said known identifiers comprise one of a source name or a home channel frequency.

20. A television terminal in accordance with claim 15, wherein:
a video service controller receives the transport stream identifier of said home channel;
said video service controller maintains a mapping of transport stream identifiers to corresponding transport streams, associated QAM channels, and destination nodes;
a VOD subsystem controller controls distribution of the requested VOD service based on commands from said video service controller;
said VOD subsystem controller commands a video pump to provide the requested VOD service to a re-multiplexing QAM device for distribution to the television terminal.

21. A television terminal in accordance with claim 20, wherein:
the video service controller services a plurality of nodes;
at least one of a common virtual channel table, a common source name table, or a common set of MPEG service numbers is used across said plurality of nodes; and
program association tables (PATs) carried in each transport stream contain unique transport stream identifiers.
